(19) United States
(12) Patent Application Publication
(10) Pub. No.: US 2011/0251859 A1
(43) Pub. Date: Oct. 13, 2011

(54) Method and Apparatus Pertaining to Facilitating Administration of a Fixed Annuity Having a Long-Term Care Rider

(75) Inventors: Wendy Catherine McCullough, New Hope, MN (US); Kim Henderson Tillmann, Minneapolis, MN (US); Jeffrey James Walentowski, Neenah, WI (US)

(73) Assignee: THRIVENT FINANCIAL FOR LUTHERANS, Appleton, WI (US)

(21) Appl. No.: 13/082,079

(22) Filed: Apr. 7, 2011

Related U.S. Application Data
(60) Provisional application No. 61/321,644, filed on Apr. 7, 2010.

(51) Int. Cl. G06Q 40/00

(52) U.S. Cl. 705/4

(57) ABSTRACT

Administering a fixed annuity having a long-term care (LTC) rider includes calculating, at a time of an insured party entering a claim period for LTC benefits and as a function of a value of a fixed annuity for an annuitant, an available insurance amount for an LTC benefit. This fixed-annuity value can comprise a present value of the fixed annuity at the time the insured party enters the claim period. These teachings will also accommodate calculating the total LTC benefits by summing the value of the fixed annuity with the value of the fixed annuity as multiplied by a multiplier. LTC benefits can be paid by apportioning a first part of the payment against the fixed annuity itself while apportioning a second part of the payment against an available insurance amount. Following depletion of the annuity, however, one can then apportion such payments only against the available insurance amount until exhausted.

### RELATED APPLICATION(S)

This application claims the benefit of U.S. Provisional application No. 61/321,644, filed Apr. 7, 2010, which is incorporated by reference in its entirety herein.

### TECHNICAL FIELD

This invention relates generally to fixed annuities.

### BACKGROUND

Fixed annuities are known in the art. Generally speaking, a fixed annuity permits a person to place a given sum of money into the annuity where the money benefits from a guaranteed interest rate (with a current interest rate that often varies to some extent in some manner on a periodic basis). In the United States this interest-based income grows tax deferred until the owner withdraws funds from the annuity. Beginning at the maturity date, owners must typically begin receiving an income regardless of their present financial needs and many fixed annuities permit the owners to earlier withdraw amounts from the annuity (either subject to or free from related charges (often referred to as a surrender charge) if they so choose).

Such annuities can provide a powerful and useful tool for managing one's finances. This can include, for example, providing funds that are available to meet financial challenges that occur during one's senior years. That said, however, a fixed annuity is a considerably different financial vehicle than a long-term care insurance product. To meet a typical insurance need such as long-term care (including such expenses incurred for services, for example, as nursing home, assisted-living, in-home care, and so forth), the traditional approach is to acquire long-term care insurance that is separate and distinct from a fixed annuity.

In fact, studies show that the majority of long-lived persons eventually need, to a greater or lesser extent, long-term care. That said, however, the vast majority of this relevant population lacks insurance for long-term care. This includes the majority of persons who have a fixed annuity. There have been a few attempts to offer a financial service that combines features of a fixed annuity with features of long-term care insurance. To date, however, these combinations do not appear to have impressed the majority of the persons who might most benefit from such a package. The combined offerings to date comprise a less-than-compelling product and service offering to those in need.

### BRIEF DESCRIPTION OF THE DRAWINGS

The above needs are at least partially met through provision of the method and apparatus pertaining to facilitating administration of a fixed annuity having a long-term care rider described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, one can facilitate administering a fixed annuity having a long-term care rider by, amongst other things, calculating, at a time of an insured party entering a claim period for long-term care benefits and as a function of a value of a fixed annuity, an available insurance amount for a long-term care benefit.

By one approach the insured party can be one and the same as the annuitant. If desired, two or more persons (such as a wife and husband) can be co-insured parties where both or only one of these parties is also the corresponding annuitant.

By one approach, the aforementioned value of the fixed annuity can comprise a present value of the fixed annuity at the time the insured party enters the claim period. These teachings will also accommodate calculating the aforementioned total benefits available for covered long-term care expenses by summing the value of the fixed annuity with the value of the fixed annuity as multiplied by a multiplier. This multiplier might be selected, for example, at the time the owner(s) initially funds the fixed annuity or adds the long-term care benefit.

These teachings will also accommodate calculating the available insurance amount for long-term care benefits by, at least in part, also calculating a corresponding maximum daily long-term care benefit.

By one approach the aforementioned administration can include determining when the fixed annuity becomes depleted. Prior to such depletion, for example, long-term care benefits can be paid by apportioning a first part of the payment (such as fifty percent or more of the total payment) against the fixed annuity itself while apportioning a second part of the payment against an available insurance benefit. At such time as the fixed annuity shall become fully depleted, however, these teachings will accommodate then apportioning such payments only against the insurance benefit until the available insurance benefit is exhausted.

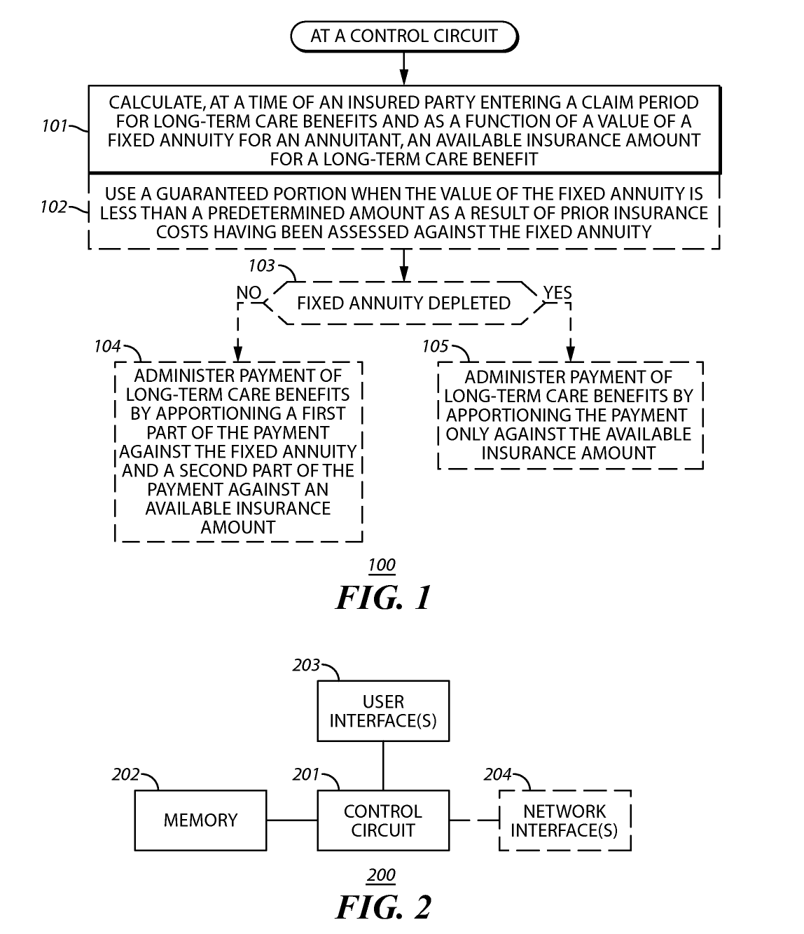

These and other benefits may become clearer upon making a thorough review and study of the following detailed description. Referring now to the drawings, and in particular to FIG. 1, an illustrative process 100 that is compatible with many of these teachings will now be presented. Generally speaking, some or all of the actions and functionality described herein can be carried out by a control circuit of choice. Further details in these regards appear below.

This process 100 presumes that one or more persons have contracted to invest in a fixed annuity of choice. This will typically include investing an up-front sum of money. This sum will typically provide an interest-based return over time. There are various approaches in these regards including provisions for varying interest rates over time, guaranteed rates, and so forth that may apply in a specific application setting. The annuity will typically specify a date by when the owner must begin to take an income from the annuity and will also often permit the annuitant to withdraw at least some portion of the annuity value at one or more earlier times (with or without corresponding surrender, or other costs). The present teachings are not particularly sensitive to specific choices in these regards and hence further elaboration will not be provided here except as may be specifically relevant to a particular discussion.

This process 100 further presumes that this fixed annuity includes provisions for long-term care insurance. In many application settings this may comprise including terms and conditions in these regards via a rider but the present teachings will also readily accommodate a more integrated consolidation and presentation of this content. In many cases, and especially where the annuity has a single annuitant, the insured party and the annuitant will be one and the same. These teachings will accommodate some variations in these regards, however, as will be shown below.

Generally speaking, these teachings provide a financial-services product that appears and functions, at least to a very large extent if not wholly, as an ordinary fixed annuity until the insured party shall enter a claim period for the aforementioned long-term care benefits. In a typical application setting, then, the annuity value can grow over time (as interest accumulates, for example) and the annuitant may withdraw funds from time to time to meet financial needs (free from or subject to surrender assessments as per the terms of the annuity).

Referring specifically to FIG. 1, however, at step 101 this process 100 provides for calculating, at a time of the insured party entering a claim period for long-term care benefits, the total amount for the long-term care benefits. More particularly, this step 101 provides for calculating this amount as a function, at least in part, of a value of the fixed annuity and the available insurance amount. The sum of the aforementioned parts equal the total available insurance amount. By one approach, this total available insurance amount, when calculated, applies thereafter regardless of whether the insured party stops needing long-term care reimbursements for a period of time and regardless of how many times in the future the insured party may present subsequent reimbursement requests. By another approach, if the fixed annuity value later increases, the total available insurance amount may increase.

In many typical application settings the present value of the fixed annuity will differ from the initial infusion that funded the annuity. On the one hand, the amount can increase over time as a function of corresponding earnings (based, for example, on interest earned by the annuity principal and previously-earned interest) or as a function of subsequent contributions from the annuitant (which might be offered or required, for example, pursuant to an inflation-protection plan). On the other hand, there are various ways by which the value of the fixed annuity can be diminished. Examples in these regards include but are not limited to insurance costs (as are assessed by the enterprise that administers the annuity with long-term care coverage on behalf of the insured), long-term care benefit payments, surrender amounts (typically comprising early withdrawals taken by the owner), and surrender charges (typically comprising fees charged by the enterprise that administers the annuity when surrenders taken by the owner are earlier than or greater than agreed-to limits in these regards), to note but a few examples in these regards.

As a result, it is possible that the present value of the annuity fund can be less than, the same as, or greater than an initially-funded value of the fixed annuity. The present teachings are highly flexible in these regards and can be successfully applied in any of these circumstances.

Approaches can vary considerably as to how the value of the fixed annuity can influence the available insurance amount. As a non-limiting example in these regards, this might comprise simply doubling the present value of the fixed annuity. As an illustration of this approach, if a particular annuity began with $100,000, and then grew over the years with interest to have a present value of $150,000, then by this approach the insurance amount available for long-term care benefits would be $300,000 and added to the annuity present value of $150,000 will provide $450,000 of total benefits for long-term care.

These teachings, of course, will support a wide variety of approaches in these regards. For example, by one approach this step could comprise summing the value of the fixed annuity with that value as multiplied by a multiplier that the annuitant (or the insured party) selected at the time of creating the fixed annuity. Such a multiplier could be essentially any number of choice including fractional amounts. By one approach, however, this multiplier can comprise relatively low-valued integers such as “1,” “2,” and the like.

To extend this example, the owner could have the choice to select a particular multiplier at the time of funding the annuity or adding the long-term care benefit. In this case, for example, a multiplier of “1” might be available with a recurring insurance cost while higher-valued multipliers might be available for a higher recurring insurance cost.

In any event, if the multiplier to apply in a given instance was “2,” then the annuity value of $150,000 (to continue with the example provided above) could be summed with that value (i.e., $150,000) multiplied by this multiplier to calculate the resultant amount of $450,000 which would then comprise the total amount for long-term care benefits.

The form of the calculated amount can vary as well, if desired. By one approach, for example, the calculated amount can simply represent a life-time benefit. By one approach, however, in combination therewith, this step 101 can include calculating a corresponding maximum daily long-term care benefit. As a simple illustration in these regards, the daily maximum benefit might be $50 unless the present value of the annuity exceeds some predetermined amount (such as, for example, $36,000) in which case the daily maximum benefit could be greater than $50. Numerous other possibilities in these same regards are also possible.

As noted above, in many application settings the enterprise that administers the fixed annuity will charge corresponding insurance costs from time to time. In many cases the value of the annuity will increase over time notwithstanding such administration fees. It might be possible, however, in some cases for such insurance costs to reduce the annuity value in a more appreciable way. This can happen, for example, when an insured is particularly elderly when they first fund their annuity or add the long-term care benefit.

To address such a circumstance, if desired, this process 100 can make use of an optional accommodation 102. In particular, the aforementioned calculation step 101 can use a guaranteed-value insurance portion of the long-term care benefit when the value of the fixed annuity is less than a predetermined amount as a result of prior insurance costs having been assessed against the fixed annuity. This predetermined amount could be, for example, 75% of the initially-funded amount.

Assume an initially-funded amount of $100,000. If the value of the annuity had dropped over the years because of the aforementioned insurance costs to, say, $50,000, then this process 100 could optionally provide for using a guaranteed value of, say, $90,000 (which can, for example, be calculated as a percentage of the initially-funded amount) to calculate the available insurance amount rather than the actual $50,000 value. In such a case (and presuming a multiplier value of “1”) the available insurance amount would be calculated as $90,000 added to the annuity value of $50,000 to result in a total benefit of $140,000.

When the insured party enters the claim period for long-term care benefits, they will likely begin to incur corresponding expenses. A typical long-term care insurance policy will not cover ordinary medical expenses such as doctor's fees, hospital fees, prescription drug costs, and so forth. But numerous other costs associated with long-term care that are occasioned by diminished health or limitations with respect to other relevant physical or mental faculties are typically covered. This can include, for example, nursing home expenses, assisted-living expenses (including both in-facility and at-home expenses), and so forth. These teachings will readily accommodate a wide range of practices in these regards.

These teachings are both flexible and highly scalable in practice. This process will optionally accommodate, for example, including other sensibly related but traditionally excluded expenses such as the installation of wheelchair ramps at one's home, caregiver training for family members, and so forth. By one approach the scope of reimbursement for such ancillary benefits can be specifically limited in some suitable fashion. This might comprise, for example, dividing the annuity value at the time of initial funding by some useful number. If “12” is used as the divisor, for example, then the maximum lifetime ancillary benefit for such traditionally excluded expenses could be calculated as approximately $8,333 (presuming, again, an initially-funded amount of $100,000).

In any event, as the insured party receives reimbursement for covered expenses pursuant to their long-term care benefits, this process 100 can optionally provide, as desired, for determining at step 103 whether the fixed annuity has become fully (or effectively) depleted for whatever reason.

Unless and until this circumstance occurs, the process 100 can provide for reimbursement of covered expenses using an approach that splits the reimbursement between the available insurance amount and the annuity itself at optional step 104. In particular, this can comprise, by one example, apportioning a first part of a given payment against the fixed annuity and apportioning a second part of the payment against the available insurance benefit.

By one approach, this might comprise apportioning that first part (which is the part that is apportioned against the annuity) in excess of fifty percent of the entire reimbursement amount such that the second part (which is the part that is apportioned against the insurance benefit) is apportioned at less than fifty percent of the entire reimbursement amount. As one illustrative but non-limiting example in these regards, the reimbursement might rely upon the annuity value for, say, seventy-five percent of the total reimbursement and upon the available insurance amount for the remaining twenty-five percent.

Such an approach can be applied, if desired, in a similar manner to long-term care covered expenses. Or, if desired, these teachings will accommodate varying this approach depending, for example, upon the expense being reimbursed. Some categories of expense, for example, might be reimbursed using a fifty/fifty apportionment approach, a thirty/seventy apportionment approach, or some other apportionment ratio of choice instead of the aforementioned seventy-five/twenty-five apportionment approach.

If and when this process 100 determines at step 103 that the fixed annuity has indeed become sufficiently depleted (such as, for example, fully depleted), this process 100 can then, at optional step 105, provide for then administering the payment of long-term care benefits by apportioning the payment only against the available insurance amount. This can continue until, for example, the available insurance amount becomes fully depleted as well.

The illustrative examples provided above tend to presume a single annuitant who is also the insured party. These teachings are flexible and powerful enough, however, to permit such a process to be similarly leveraged in favor of a plurality of parties.

By one example in these regards, the fixed annuity can relate to a single annuitant but can provide long-term care benefits for two insured parties.

As another example in these regards, the fixed annuity can correspond to two annuitants (such as, for example, a married couple). In either of the two illustrative examples just offered, the above-described steps could be carried out as described when either of the insured parties makes that initial claim for long-term care benefits such that the calculated available insurance amount for long-term care benefits applies jointly to both of the insured parties.

It is of course possible that a given annuitant will reach the age at which they must begin withdrawing from their annuity without the insured party ever entering a claim period for long-term care benefits. By one approach, these teachings can optionally permit treating that forced withdrawal date as being the equivalent of entering a claim for the purposes of calculating the available long-term care benefits as otherwise described above. Using this approach, the insured party will receive the maximum insurance benefit notwithstanding that the actual annuity value might be smaller when they subsequently first enter such a claim period.

As another related accommodation, these teachings will also optionally permit not requiring the annuitant to begin making required withdrawals if they are, in fact, receiving long-term care benefits the year that requirement would otherwise become in force and effect.

The above-described teachings are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform 200 will now be provided.

In this example the enabling platform 200 includes a control circuit 201 of choice that operably couples to a memory 202. Such a control circuit 201 can comprise a fixed-purpose hard-wired platform or can comprise a partially or wholly programmable platform. All of these architectural options are well known and understood in the art and require no further description here.

This memory 202 can serve to store, for example, the aforementioned value of the fixed annuity. This memory 202 can also serve to store, temporarily or otherwise as desired, the other described calculated values. When the control circuit 201 comprises a partially or wholly-programmable component, device, network, or the like, this memory 202 can also comprise a non-transitory executable computer code storage medium for programming that, when executed by the control circuit 202, effects one or more of the steps, actions, or functions described herein as desired.

Depending upon the needs of or opportunities offered by a given application setting, this platform 200 can further optionally comprise one or more user interfaces 203. These can include, for example, user input devices (such as keyboards, cursor-control devices, and the like) and user output devices (such as displays, audio transducers, printers, and the like) that operably coupled to the control circuit 201. This can facilitate, for example, entering information regarding the initially-funded annuity value, multiplier values, and long-term care costs, to note but a few examples in these regards. This can also facilitate, for example, passing along information regarding the annuity, reimbursed long-term care expenses, the calculated available insurance amount for the long-term care benefit, and so forth.

This platform 200 can also optionally include one or more network interface 204 that operably couple to the control circuit 201. These network interfaces 204 can permit the control circuit 201 to effect communications and data exchange with, for example, local or remote resources via wireless or non-wireless carriers as appropriate.

Such a platform 200 may be comprised of a plurality of physically distinct elements as is suggested by the illustration shown in FIG. 2. It is also possible, however, to view this illustration as comprising a logical view, in which case one or more of these elements can be enabled and realized via a shared platform. Those skilled in the art will also understand and appreciate that the control circuit 201 can itself comprise a plurality of relatively independent processors (such as a first processor that administers annuities and another processor that administers long-term care benefits) that communicate with one another (for example, by passing back and forth one or more relevant files) to carry out the described capabilities.

So configured, a owner can arrange for long-term care benefits that benefit from a kind of co-semi-self insurance that, for many persons, yields comparable benefits for less insurance cost that would typically be expected for segregated long-term care insurance. On the other hand, by delaying a calculation of the available long-term care benefit until that initial time of need, the enterprise providing this protection is itself protected to some extent as withdrawals that the annuitant might take from the annuity prior to claiming their long-term care benefits will reduce the insurance liability as well. Overall, the thoughtful and careful integration of a fixed annuity with long-term care benefits as contemplated herein includes a variety of options, opportunities, and useful inducements that provide great flexibility for the annuitant to both plan sensibly for the future while meeting immediate needs in ways that best suit their circumstances at the time.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

As one simple example in these regards, payment of a death benefit pertaining to the annuity might be delayed by some suitable period (such as, for example, thirty, sixty, or ninety days) to permit receiving and paying final long-term care expenses for a now-deceased insured party. Such a delay can be eschewed, of course, if these teachings are employed in conjunction with a long-term care approach that relies upon a per diem payment as the benefit mechanism rather than a reimbursement approach.

As another simple example in these regards, when limiting reimbursement to a daily maximum cap and when more than one person is covered by the long-term care benefit, these teachings will accommodate applying that cap separately to each party individually or, in the alternative, to applying that cap jointly to all insured parties such that the insured parties share the same cap and can apportion their reimbursement amongst themselves as they see fit.

We claim:

1. An apparatus to facilitate administering a fixed annuity having a long-term care rider, the apparatus comprising:
a memory having stored therein, for an annuitant:
a value of a fixed annuity;
a control circuit operably coupled to the memory and configured to:
calculate, at a time of an insured party entering a claim period for long-term care benefits and as a function of the value of the fixed annuity, a long-term care benefit.

2. The apparatus of claim 1 wherein the value of the fixed annuity comprises a present value of the fixed annuity when the insured party enters the claim period for the long-term care benefits.

3. The apparatus of claim 1 wherein the memory further stores a multiplier and wherein calculating total benefits available for covered long-term care expenses comprises summing the value of the fixed annuity with the value of the fixed annuity as multiplied by the multiplier.

4. The apparatus of claim 1 wherein calculating the long-term care benefit further comprises calculating a corresponding maximum daily long-term care benefit.

5. The apparatus of claim 1 wherein the control circuit is further configured to:
administer payment of long-term care benefits by apportioning a first part of the payment against the fixed annuity and a second part of the payment against an available insurance amount.

6. The apparatus of claim 5 wherein the control circuit is further configured to:
administer payment of long-term care benefits by apportioning the payment only against the available insurance amount when the fixed annuity is depleted.

7. The apparatus of claim 6 wherein the first part of the payment comprises an amount in excess of fifty percent of the payment and the second part of the payment comprises an amount less than fifty percent of the payment.

8. The apparatus of claim 1 wherein the control circuit is further configured to:
calculate the long-term care benefit by using a guaranteed portion when the value of the fixed annuity is less than a predetermined amount as a result of prior insurance costs having been assessed against the fixed annuity.

9. The apparatus of claim 1 wherein the fixed annuity corresponds to two insureds, and wherein the control circuit is configured to:
calculate, at a time of either of the two insureds entering a claim period for long-term care benefits and as a function of the value of the fixed annuity, an available insurance amount for long-term care benefits that applies to both of the two insureds.

10. The apparatus of claim 1 wherein the value of the fixed annuity can be less than an initially-funded value of the fixed annuity as a result of at least one of:
insurance costs;
long-term care benefit payments;
a surrender;
a surrender charge.

11. A method to facilitate administering a fixed annuity having a long-term care rider, the method comprising:
by a control circuit:
calculating, at a time of an insured party entering a claim period for long-term care benefits and as a function of a value of a fixed annuity for an annuitant, an available insurance amount for a long-term care benefit.

12. The method of claim 11 wherein the value of the fixed annuity comprises a present value of the fixed annuity when the insured party enters a claim period for the long-term care benefits.

13. The method of claim 11 wherein calculating the total benefits available for covered long-term care expenses comprises summing the value of the fixed annuity with the value of the fixed annuity as multiplied by a multiplier.

14. The method of claim 11 wherein calculating the available insurance amount for long-term care benefit further comprises calculating a corresponding maximum daily long-term care benefit.

15. The method of claim 11 further comprising:
administering payment of long-term care benefits by apportioning a first part of the payment against the fixed annuity and a second part of the payment against an available insurance benefit.

16. The method of claim 15 further comprising:
administering payment of long-term care benefits by apportioning the payment only against the available insurance amount when the fixed annuity is depleted.

17. The method of claim 15 wherein the first part of the benefit payment comprises an amount in excess of fifty percent of the benefit payment and the second part of the benefit payment comprises an amount less than fifty percent of the benefit payment.

18. The method of claim 11 further comprising:
calculating the long-term care benefit by using a guaranteed portion when the value of the fixed annuity is less than a predetermined amount as a result of prior insurance costs having been assessed against the fixed annuity.

19. The method of claim 11 wherein the fixed annuity corresponds to two insureds, and wherein calculating the available insurance amount for long-term care benefits comprise, at a time of either of the two insureds entering a claim period for long-term care benefits and as a function of the value of the fixed annuity, calculating an available insurance amount for long-term care benefit that applies to both of the two insureds.

20. The method of claim 11 wherein the value of the fixed annuity can be less than an initially-funded value of the fixed annuity as a result of at least one of:
insurance costs;
long-term care benefit payments;
a surrender amount;
a surrender charge.
